(19) United States
(12) Patent Application Publication
(10) Pub. No.: US 2026/0316814 A1
(43) Pub. Date: Oct. 15, 2026

(54) BRAKE MECHANISM, BRAKE SYSTEM AND CHILD CARRIER

(71) Applicant: WONDERLAND SWITZERLAND AG, Steinhausen (CH)

(72) Inventor: Guanghui Zhao, Dongguan, Guangdong (CN)

(21) Appl. No.: 19/116,614

(22) PCT Filed: Sep. 29, 2023
(86) PCT No.: PCT/EP2023/077023

§ 371 Date: Mar. 28, 2025

(30) Foreign Application Priority Data
Sep. 30, 2022 (CN) 202211216663.8

(51) Int. Cl. B62B 9/08; F16D 63/00; F16D 65/16; F16D 121/14; F16D 125/62; F16D 127/02

(52) U.S. Cl. CPC B62B 9/082; B62B 9/087; F16D 63/006; F16D 65/16; F16D 2121/14; F16D 2125/62; F16D 2127/02

(57) ABSTRACT

The present disclosure discloses a brake mechanism, a brake system and a child carrier. A brake mechanism configured to lock a first wheel, includes: a first pedal having a first pop-up position and a first retracted position, one of the first pop-up position and the first retracted position corresponding to a locked state of the brake mechanism, the other of the first pop-up position and the first retracted position corresponding to an unlocked state of the brake mechanism; and a second pedal operatively connected to the first pedal and having a second pop-up position and a second retracted position. When the first pedal is in the first retracted position, the second pedal is in the second pop-up position; and when the second pedal is in the second retracted position, the first pedal is in the first pop-up position.

### CROSS REFERENCE TO RELATED APPLICATION

This application claims priority to Chinese patent application No. 2022112166638, filed on Sep. 30, 2022, the entire content of which is incorporated herein by reference in its entirety.

### TECHNICAL FIELD

The present disclosure relates to the technical field of brakes, in particular, to a brake mechanism, a brake system and a child carrier.

### BACKGROUND

A stroller is usually provided with a brake mechanism, which is used to lock wheels to prevent the stroller from moving undesirably. A typical brake mechanism includes a brake pedal. When the stroller needs to be braked, a user steps on the brake pedal, such that the brake pedal is pivoted downward, and the brake mechanism is in a locked state for locking the wheels. Conversely, when it is necessary to move the stroller, the user raises the brake pedal with his/her foot, such that the brake pedal is pivoted upward, and the brake mechanism is in the unlocked state of releasing the wheels.

### SUMMARY

The present disclosure is directed to providing a brake mechanism, a brake system and a child carrier that are convenient for braking and unbraking.

In an aspect, the present disclosure provides a brake mechanism configured to lock a first wheel. The brake mechanism includes: a first pedal having a first pop-up position and a first retracted position, one of the first pop-up position and the first retracted position corresponding to a locked state of the brake mechanism, the other of the first pop-up position and the first retracted position corresponding to an unlocked state of the brake mechanism; and a second pedal operatively connected to the first pedal and having a second pop-up position and a second retracted position. When the first pedal is in the first retracted position, the second pedal is in the second pop-up position; and when the second pedal is in the second retracted position, the first pedal is in the first pop-up position.

In an embodiment, the first pedal is capable of moving in a linear direction; and the second pedal is sleeved on a first pivot shaft, and is capable of rotating around the first pivot shaft.

In an embodiment, the first pedal includes a first pressing portion, and the second pedal includes a second pressing portion. When the first pedal moves from the first pop-up position to the first retracted position, the first pressing portion abuts against the second pressing portion, so as to drive the second pedal to move from the second retracted position to the second pop-up position.

In an embodiment, the brake mechanism further includes a limiting structure. The limiting structure is configured to lock the first pedal to the first pop-up position. When the second pedal moves toward the second retracted position, the second pedal drives the first pedal to be unlocked from the limiting structure.

In an embodiment, the brake mechanism further includes a first elastic member configured to drive the first pedal to move from the first retracted position to the first pop-up position; and/or a second elastic member configured to drive the second pedal to rotate from the second pop-up position to the second retracted position.

In an embodiment, a moving direction of the first pedal is perpendicular to an axial direction of the first pivot shaft.

In an embodiment, the first pedal further includes a first treading portion and a body portion connected to the first treading portion. The first pressing portion includes an elastic arm extending from the body portion. The elastic arm extends obliquely relative to a moving direction of the first pedal.

In an embodiment, the second pedal further includes a second treading portion and a pivot portion connected to the second treading portion. The pivoting portion is sleeved on the first pivot shaft. The second pressing portion includes a bearing plate extending from the pivoting portion. A plane where the bearing plate is positioned intersects a plane where the second treading portion is positioned.

In an embodiment, the elastic arm includes a protruding block configured to push the bearing plate to rotate.

In an embodiment, the brake mechanism further includes a limiting step. When the first pedal is in the first retracted position, the limiting step is engaged with the elastic arm, so as to lock the first pedal in the first retracted position, and to keep the second pedal in the second pop-up position. When second pedal moves toward the second retracted position, the second pressing portion drives the elastic arm to elastically deform, such that the elastic arm is disengaged from the limiting step.

In an embodiment, the elastic arm includes an inclined wall and an end wall. A protruding block is disposed on the inclined wall. When the first pedal moves toward the first retracted position, the inclined wall abuts against the limiting step and allows the protruding block to abut against the second pressing portion. When the first pedal is in the first retracted position, the end wall is engaged with the limiting step.

In an embodiment, the brake mechanism further includes: a first rotatable plate sleeved on a second pivot shaft, an end wall of the first rotatable plate including a first inclined portion extending in a circumferential direction, the first inclined portion including a first protruding end and a first avoiding end; and a first locking pin parallel to the second pivot shaft and abutting against the first inclined portion. When the first locking pin abuts against the first protruding end, the first locking pin is in an extended position. When the first locking pin abuts against the first avoiding end, the first locking pin is in a retracted position. When the first pedal moves between the first pop-up position and the first retracted position, the first rotatable plate rotates accordingly, such that the first locking pin selectively abuts against the first protruding end and the first avoiding end.

In an embodiment, when the first pedal moves from the first pop-up position to the first retracted position, the first pedal drives the first rotatable plate to rotate in a first direction. The brake mechanism further includes a third elastic member. When the first pedal moves from the first retracted position to the first pop-up position, the third elastic member drives the first rotatable plate to rotate in a second direction. The second direction is opposite to the first direction.

In an embodiment, the first pedal is capable of moving in a radial direction of the second pivot shaft. One of the first pedal and the first rotatable plate includes a transmission portion, the other of the first pedal and the first rotatable plate is provided with a transmission surface. The transmission surface is inclined relative to a moving direction of the first pedal, and the transmission portion abuts against the transmission surface.

In an embodiment, the first pedal further includes a first treading portion and a body portion connected to the first treading portion. The transmission portion protrudes outwardly from the body portion. The first rotatable plate includes a disc-shaped body and a push rod arranged coaxially with the disc-shaped body. The disc-shaped body includes a blocking portion. The push rod is clamped between the transmission portion and the blocking portion. The transmission surface is formed on the push rod.

In an embodiment, the first pedal and the second pedal are capable of moving in a linear direction. The first pedal is connected to the second pedal by a connecting rod. A middle portion of the connecting rod is pivotally connected to a pivot base.

In another aspect, a brake system is provided. The brake system includes an auxiliary brake mechanism, a pulling member, and the brake mechanism as described above. The first rotatable plate is operatively connected to the auxiliary brake mechanism through the pulling member. The auxiliary brake mechanism is configured to lock the second wheel.

In an embodiment, a first end of the pulling member is provided with a connecting head, and a second end of the pulling member is connected to the auxiliary brake mechanism. The brake mechanism is provided with a sliding slot slidably fitted with the connecting head. The sliding slot includes a radially outer end and a radially inner end. The connecting head is movably connected to the first rotatable plate. When the first rotatable plate rotates, the connecting head is capable of moving between the radially outer end and the radially inner end of the sliding slot.

In an embodiment, the first rotatable plate includes a concave portion configured to receive the connecting head. The concave portion includes an abutting wall slidably fitted with the connecting head.

In an embodiment, the auxiliary brake mechanism includes: a second rotatable plate sleeved on a third pivot shaft, an end wall of the second rotatable plate including a second inclined portion extending in a circumferential direction, and the second inclined portion including a second protruding end and a second avoiding end; and a second locking pin parallel to the third pivot shaft and abutting against the second inclined portion. When the second locking pin abuts against the second protruding end, the second locking pin is in an extended position to lock the second wheel. When the second locking pin abuts against the second avoiding end, the second locking pin is in a retracted position to unlock the second wheel. The second end of the pulling member is connected to the second rotatable plate. When the connecting head moves between the radially outer end and the radially inner end of the sliding slot, the second rotatable plate rotates accordingly, such that the second locking pin selectively abuts against the second protruding end and the second avoiding end.

In yet another aspect, an embodiment of the present disclosure further provides a child carrier, including a movable frame; and the brake mechanism as described above provided on the movable frame, or the brake system as described above provided on the movable frame.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a perspective view of a brake mechanism and a first wheel according to an embodiment of the present disclosure, in which a first pedal is in a first pop-up position, and a second pedal is in a second retracted position.

FIG. 2 is a perspective view of a brake mechanism and a first wheel according to an embodiment of the present disclosure, in which a first pedal is in a first retracted position, and a second pedal is in a second pop-up position.

FIG. 3 is a perspective view of a brake mechanism and a first wheel that are separated from each other according to an embodiment of the present disclosure, in which a first end cover is omitted for ease of illustration, a first pedal is in a first retracted position, and a second pedal is in a second pop-up position.

FIG. 4 is an exploded view of a brake mechanism according to an embodiment of the present disclosure.

FIG. 5 is a perspective view of a brake mechanism and a first wheel according to an embodiment of the present disclosure, in which a first end cover is omitted for ease of illustration, a first pedal is in a first pop-up position, and a second pedal is in a second retracted position.

FIG. 6 is a perspective view of a first pedal and a first rotatable plate of a brake mechanism according to an embodiment of the present disclosure.

FIG. 7 is a cross-sectional view of a brake mechanism according to an embodiment of the present disclosure, in which a first pedal is in a first pop-up position, and a second pedal is in a second retracted position.

FIG. 8 is a cross-sectional view of a brake mechanism according to an embodiment of the present disclosure, in which a first pedal moves toward a first retracted position.

FIG. 9 is a cross-sectional view of a brake mechanism according to an embodiment of the present disclosure, in which a first pedal is in a first retracted position, and a second pedal is in a second pop-up position.

FIG. 10 is a perspective view of a brake mechanism according to an embodiment of the present disclosure, in which an intermediate housing and a second end cover are omitted for ease of illustration, a first pedal is in a first pop-up position, and a first locking pin is in a retracted position.

FIG. 11 is a perspective view of a brake mechanism according to an embodiment of the present disclosure, in which an intermediate housing and a second end cover are omitted for ease of illustration, a first pedal is in a first retracted position, and a first locking pin is in an extended position.

FIG. 12 is a perspective view of an auxiliary brake mechanism, a second wheel, and a movable frame that are separated from each other of a brake system according to an embodiment of the present disclosure, in which a second locking pin is in a retracted position.

FIG. 13 is a perspective view of an auxiliary brake mechanism, a second wheel, and a movable frame that are separated from each other of a brake system according to an embodiment of the present disclosure, in which a second locking pin is in an extended position.

### DETAILED DESCRIPTION OF THE EMBODIMENTS

In order to make the object, technical solution, and advantages of the present disclosure clearer, the present disclosure will be further described in detail below in conjunction with the accompanying drawings and specific embodiments. It should be understood that the specific embodiments described herein are only used to illustrate the present disclosure, and do not limit the protection scope of the present disclosure.

It should be noted that when a component is referred as to be “fixed to” another component, it may be directly on the other component or there may also be an intermediate component. When a component is referred as to be “connected to” to another component, it may be directly connected to the other component or there may be an intermediate component at the same time. The terms “vertical,” “horizontal,” “left,” “right,” and similar expressions are used herein for purposes of illustration only and are not intended to represent the only embodiments.

Unless otherwise defined, all technical and scientific terms used herein have the same meaning as commonly understood by one of ordinary skill in the technical field to which the present disclosure belongs. The terms used herein in the description of the present disclosure is only for the purpose of describing specific embodiments, and is not intended to limit the present disclosure. As used herein, the term “and/or” includes any and all combinations of one or more of the associated listed items.

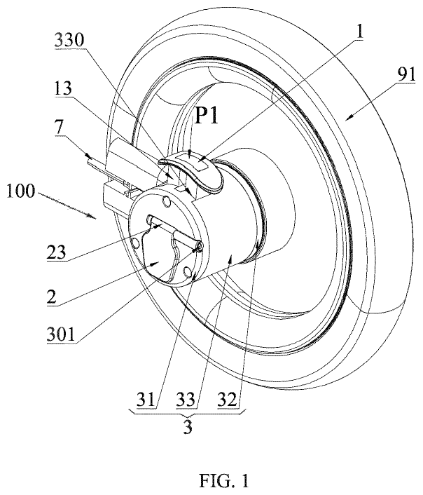

Referring to FIGS. 1 to 4, a brake mechanism 100 according to an embodiment of the present disclosure is shown. The brake mechanism 100 is configured to lock a first wheel 91. The first wheel 91 can be, for example, a right rear wheel of a stroller. It can be understood that although the brake mechanism 100 of this embodiment being applied to the stroller is described as an example, the disclosure range of the brake mechanism 100 is not limited to the stroller, and the brake mechanism 100 can also be applied to other child carries with a movable frame or supermarket carts and other products.

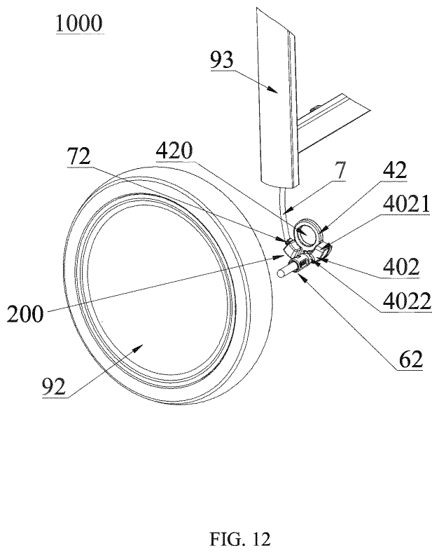

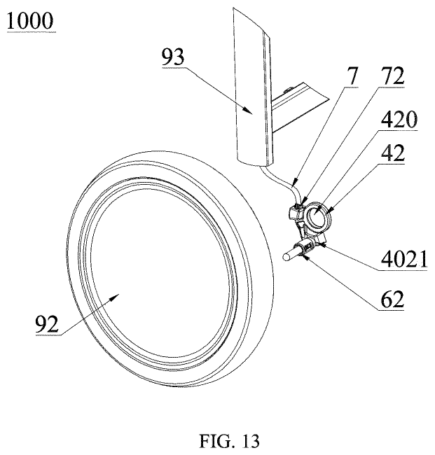

Referring to FIGS. 1 to 4, the brake mechanism 100 includes a first pedal 1, a second pedal 2, and a housing 3. The first pedal 1 and the second pedal 2 can be mounted on the housing 3. The housing 3 can be mounted on a rear leg frame 93 of a movable frame, FIGS. 12 and 13 shows the rear leg frame 93 and a second wheel 92 mounted on the rear leg frame 93. The second wheel 92 is a left rear wheel, for example. The rear leg frame 93 is substantially symmetrical in a left-right direction. In some embodiments, the housing 3 includes, for example, a first end cover 31, an intermediate housing 33, and a second end cover 32. The intermediate housing 33 is connected to the rear leg frame 93. The first end cover 31 is mounted on an end of the intermediate housing 33. The second end cover 32 is mounted on the other end of the intermediate housing 33. In other embodiments, the configuration of the housing 3 is not limited to the above, and the housing 3 can be implemented in various ways according to needs.

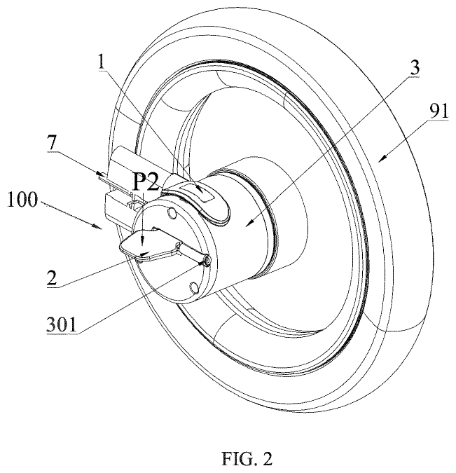

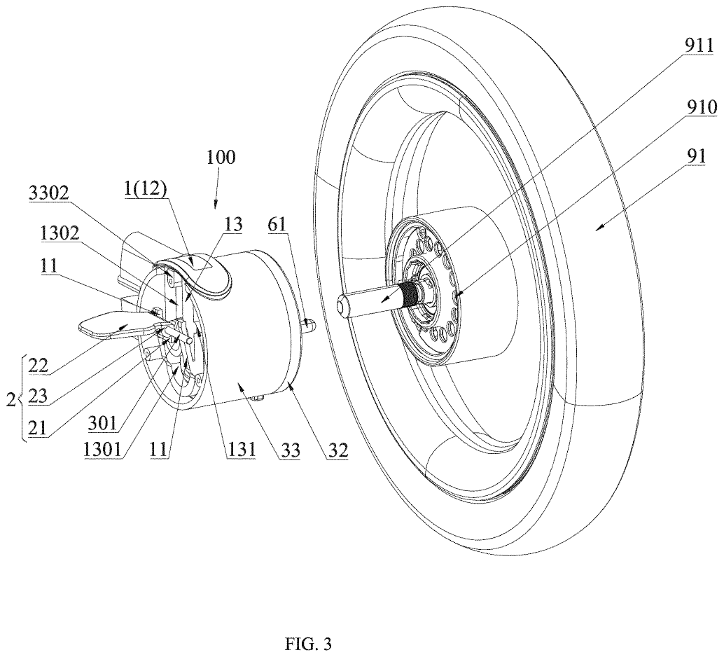

Referring to FIGS. 1 and 2, the first pedal 1 has a first pop-up position and a first retracted position. When the first pedal 1 moves between the first pop-up position and the first retracted position, a first locking pin 61 of the brake mechanism 100 (see FIG. 3) moves between an extended position and a retracted position, and the brake mechanism 100 is correspondingly switched between a locked state and an unlocked state. Referring to FIG. 3, in some embodiments, the first locking pin 61 retractably extends through a hole (not shown) of the second end cover 32. When the first pedal 1 is subjected to a first pressure P1 to be stepped on to the first retracted position, the first locking pin 61 is driven to move to the extended position, and in this case, the first locking pin 61 extends out of the second end cover 32 to be engaged with a locking portion 910 (which may be a hole or a groove) of the first wheel 91, and thus the brake mechanism 100 is in the locked state in which the first wheel 91 is locked. In contrast, when the first pedal 1 returns to the first pop-up position, the first locking pin 61 returns to the retracted position, and in this case, the first locking pin 61 is retracted relative to the second end cover 32 to be disengaged from the locking portion 910 of the first wheel 91, such that the brake mechanism 100 is in the unlocked state in which the first wheel 91 is unlocked.

In some alternative embodiments, when the first pedal 1 is in the first pop-up position, the first locking pin 61 is in the extended position and is engaged with the locking portion of the first wheel 91, such that the brake mechanism 100 is in the locked state. When the first pedal 1 is in the first retracted position, the first locking pin 61 is in the retracted position and is disengaged from the locking portion of the first wheel 91, such that the brake mechanism 100 is in the unlocked state.

Continuing to refer to FIGS. 1 and 2, the second pedal 2 has a second pop-up position and a second retracted position, and the second pedal 2 is operatively connected to the first pedal 1. When the first pedal 1 moves from the first pop-up position to the first retracted position, for example, subjected to the first pressure P1, the movement of the first pedal 1 causes the second pedal 2 to move from the second retracted position to the second pop-up position. When the first pedal 1 is in the first retracted position, the second pedal 2 is in the second pop-up position. In contrast, when the second pedal 2 is subjected to the second pressure P2 to be stepped on, the second pedal 2 moves from the second pop-up position to the second retracted position, and the movement of the second pedal 2 may cause the first pedal 1 to move from the first retracted position to the first pop-up position. When the second pedal 2 is in the second retracted position, the first pedal 1 is in the first pop-up position. It should be noted that the term “operatively connection” in the embodiments of the present disclosure includes, but is not limited to, direct connection, indirect connection, fixed connection, pivotal connection, pressing contact or the like. When two components are operatively connected to each other, it means that the movement of one of the two components can cause the movement of the other of the two components.

When the brake mechanism 100 according to the embodiment of the present disclosure locks the first wheel 91 and unlocks the first wheel 91, the first pedal 1 or the second pedal 2 may be stepped on correspondingly, and there is no need to raise the foot against the first pedal 1 or the second pedal, which would not cause injury to user's vamp or instep. The way of stepping down is more in line with the user's living habits, which is convenient for the user to apply force and provides a better use experience to the user.

In some embodiments, the first pedal 1 and the second pedal 2 can be operatively connected to each other by any suitable intermediate structure, such that the first pedal 1 and the second pedal 2 are operatively connected, and a change in the position of one of the first pedal 1 and the second pedals 2 causes an opposite change in the position of the other of the first pedal 1 and the second pedals 2. For example, in some other embodiments, both the first pedal 1 and the second pedal 2 are moved in a linear direction, and a moving direction of the first pedal 1 is parallel to that of the second pedal 2, and the first pedal 1 is connected to the second pedal 2 by a connecting rod. A middle portion of the connecting rod is pivotally connected to a pivot base. The pivot base can be fixed in the housing 3. As such, when the first pedal 1 is subjected to a pedaling force and moves down to be retracted, the connecting rod is pivoted and drives the second pedal 2 to move upward and pop up. Similarly, when the second pedal 2 is subjected to a pedaling force and moves down to be retracted, the connecting rod is pivoted and drives the first pedal 1 to move upward and pop up. In other words, when the first pedal 1 moves from the first pop-up position to the first retracted position, the first pedal 1 drives the second pedal 2 to move from the second retracted position to the second pop-up position.

Referring to FIGS. 1, 2, and 4, in some embodiments, the intermediate housing 33 of the housing 3 is provided with an opening 330. The first pedal 1 extends through the opening 330. The first pedal 1 moves in the linear direction to the first pop-up position or first retracted position. In some embodiments, the moving direction of the first pedal 1 is, for example, an up-down direction. The first end cover 31 of the housing 3 is provided with a first pivot shaft 301. The second pedal 2 is sleeved on the first pivot shaft 301, and the second pedal 2 rotates around the first pivot shaft 301 to the second pop-up position or the second retracted position. In some embodiments, the first pivot shaft 301 is arranged horizontally, and a moving direction of the first pedal 1 is perpendicular to an axial direction of the first pivot shaft 301. The first pedal 1 moving linearly and the second pedal 2 moving pivotally can drive each other by directly abutting against each other, which is beneficial to the overall layout and compact configuration of the brake mechanism.

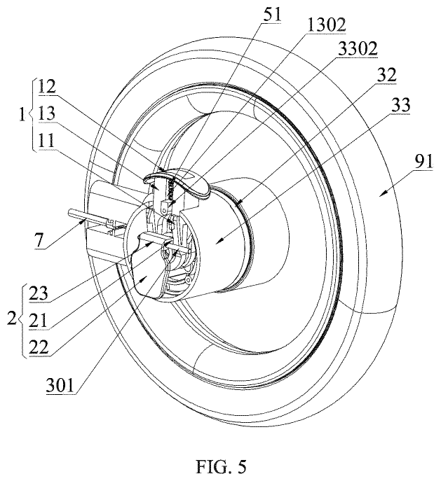

Referring to FIG. 5, in some embodiments, the first pedal 1 may include a first pressing portion 11, and the second pedal 2 may include a second pressing portion 21. When the first pedal 1 is subjected to the first pressure P1 and moves from the first pop-up position to the first retracted position, the first pressing portion 11 can abut against the second pressing portion 21, thereby driving the second pedal 2 to move from the second retracted position to the second pop-up position. In contrast, when the second pedal 2 is subjected to the second pressure P2 and moves from the second pop-up position to the second retracted position, the second pressing portion 21 can act on the first pressing portion 11 to help the first pedal 1 move from the first retracted position to the first pop-up position.

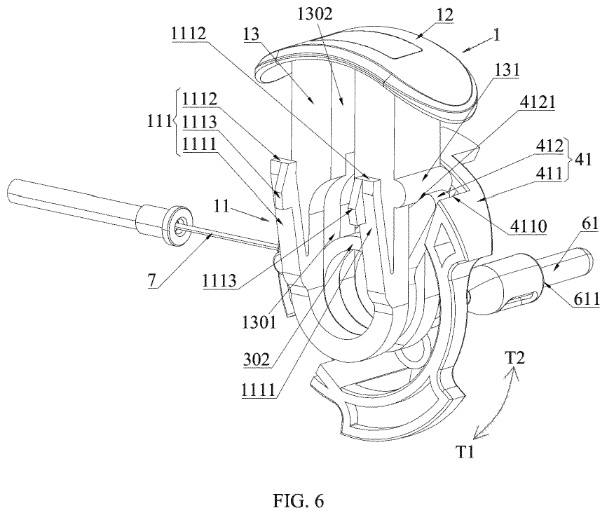

FIG. 6 shows an exemplary configuration of the first pressing portion 11. The first pedal 1 further includes a first treading portion 12 and a body portion 13 connected to the first treading portion 12. The first treading portion 12 is positioned outside the housing 3 and is configured to receive the first pressure P1. The body portion 13 protrudes into the housing 3 through the opening 330. The first pressing portion 11 includes an elastic arm 111 extending from the body portion 13. The elastic arm 111 extends obliquely relative to the moving direction of the first pedal 1. In some embodiments, the number of elastic arms 111 can be set as required. In some embodiments, a lower end of the elastic arm 111 is engaged with the body portion 13, and an upper end of the elastic arm 111 is separated from the body portion 13. When the first pedal 1 in the first pop-up position is subjected to the first pressure P1, the upper end of the elastic arm 111 can abut against the second pressing portion 21 of the second pedal 2, thereby pushing the second pedal 2 to rotate around the first pivot shaft 301, such that the second pedal 2 can move from the second retracted position to the second pop-up position.

FIG. 5 shows an exemplary configuration of the second pressing portion 21. The second pedal 2 further includes a second treading portion 22 and a pivot portion 23 connected to the second treading portion 22. The second treading portion 22 is configured to receive the second pressure P2, and the pivoting portion 23 is sleeved on the first pivot shaft 301. The second pressing portion 21 includes a bearing plate 211 extending from the pivoting portion 23. A plane where the bearing plate 211 is positioned intersects a plane where the second treading portion 22 is positioned. In some embodiments, the plane where the force bearing plate 211 is positioned is perpendicular to or nearly perpendicular to the plane where the second pedal 22 is positioned. When the elastic arm 111 moves downward, the elastic arm 111 can directly push the bearing plate 211 to rotate around the first pivot shaft 301, such that the second pedal 2 can move to the second pop-up position. In some embodiments, the upper end of the elastic arm 111 can be provided with a protruding block 1113. When the elastic arm 111 moves downward with the first pedal 1, the protruding block 1113 can hook the bearing plate 211 to easily push the bearing plate 211 to rotate.

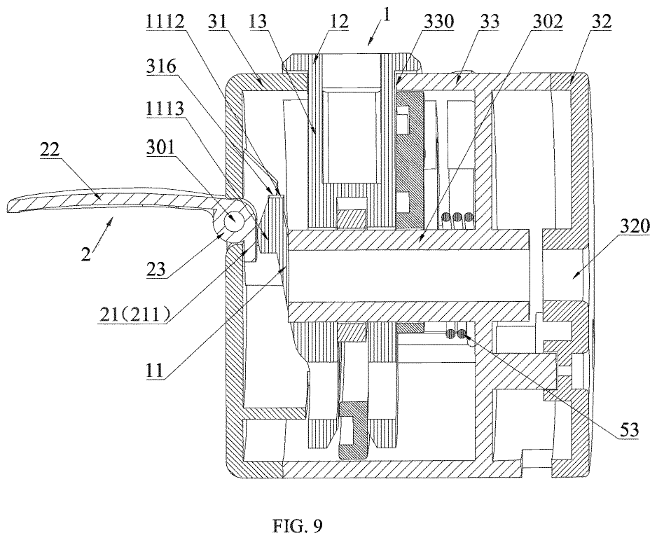

Referring to FIG. 9, when the second pedal 2 is in the second pop-up position, the second treading portion 22 of the second pedal 2 is generally parallel to the ground, such that the second pressure P2 is applied to the second pedal 2 from up to down, and the second pedal 2 is pivoted downward around the first pivot shaft 301 to the second retracted position. In some embodiments, when the second pedal 2 is in the second pop-up position, the second treading portion 22 can also be inclined relative to the ground. Referring to FIG. 1, in some embodiments, the second pedal 2 in the second retracted position can be attached to the first end cover 31.

In some embodiments, the brake mechanism 100 can further include a limiting structure (for example, a limiting step 316 hereinafter). When the first pedal 1 is subjected to the first pressure P1 and moves from the first pop-up position to the first retracted position, the first pedal 1 can be locked in the first retracted position by the limiting structure. In this case, the first pressing portion 11 abuts against the second pressing portion 21 to keep the second pedal 2 in the second pop-up position. When the second pedal 2 is subjected to the second pressure P2 and moves from the second pop-up position to the second retracted position, the second pedal 2 drives the first pedal 1 to be unlocked from the limiting structure, so as to allow the first pedal 1 to move to the first pop-up position.

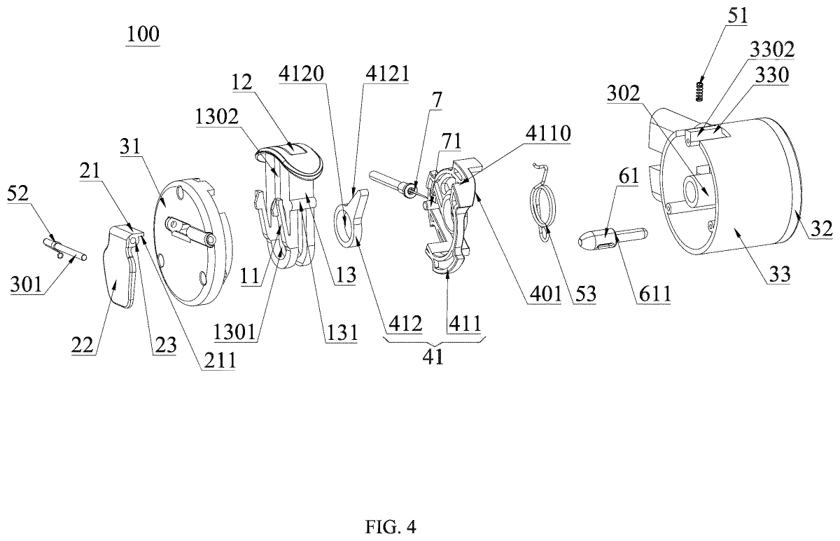

Referring to FIGS. 4 and 5, in some embodiments, the brake mechanism 100 can further include a first elastic member 51. The first elastic member 51 can be mounted, for example, between the housing 3 and the first pedal 1, so as to drive the first pedal 1 to move from the first retracted position to the first pop-up position. In this way, when the first pedal 1 is unlocked from the limiting structure, it can automatically move to the first pop-up position. In some embodiments, the brake mechanism 100 can further includes a second elastic member 52. The second elastic member 52 is configured to drive the second pedal 2 to move from the second pop-up position to the second retracted position. The second elastic member 52 is, for example, a torsion spring, sleeved on the first pivot shaft 301 and connected to the first end cover 31 and the second pedal 2, respectively. When the second pedal 2 in the second pop-up position is subjected to the second pressure P2 and rotates downward, after the first pedal 1 is unlocked from the limiting structure, even if the second pressure P2 is removed, the second pedal 2 can automatically move to the second retracted position under the action of the elastic member 52, and the second pedal 2 is kept in the second retracted position without shaking randomly.

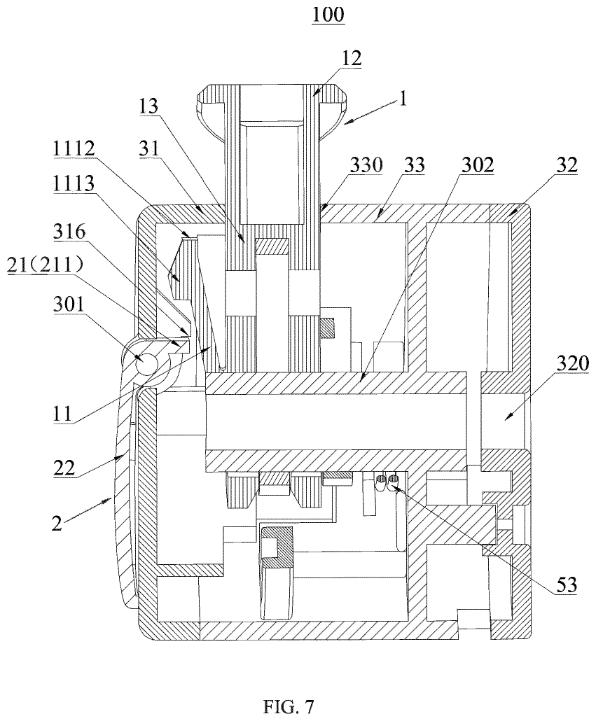

The limiting structure can be implemented in various ways, as long as the above-mentioned function of locking or unlocking the first pedal 1 can be achieved. Referring to FIGS. 7 to 9, in some embodiments, the limiting structure includes, for example, a limiting step 316. The limiting step 316 can be disposed on an inner wall of the first end cover 31. When the first pedal 1 is in the first retracted position, the limiting step 316 is engaged with the elastic arm 111 to lock the first pedal 1 in the first retracted position, and the second pedal 2 is correspondingly maintained in the second pop-up position. When the second pedal 2 moves toward the second retracted position, the bearing plate 211 of the second pressing portion 21 drives the elastic arm 111 to elastically deform, such that the elastic arm 111 is disengaged from the limiting step 316, that is, the locking of the elastic arm 111 by the limiting step 316 is released.

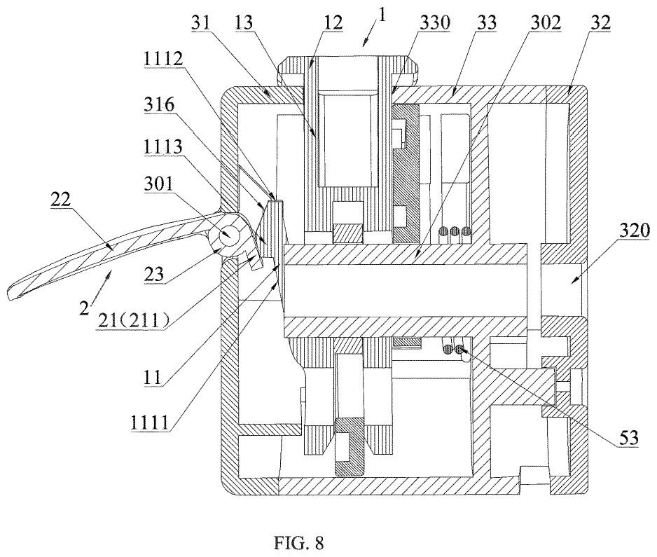

Referring to FIG. 6, in some embodiments, the elastic arm 111 includes an inclined wall 1111 and an end wall 1112. The aforementioned protruding block 1113 is disposed on a part of the inclined wall 1111. Referring to FIG. 8, during the movement of the first pedal 1 from the first pop-up position to the first retracted position, the inclined wall 1111 abuts against the limiting step 316 and allows the protruding block 1113 to abut against the bearing plate 211 of the second pressing portion 21, so as to drive the second pedal 2 to rotate toward the second pop-up position. Referring to FIG. 9, when the first pedal 1 is in the first retracted position, the inclined wall 1111 extends over the limiting step 316, the elastic arm 111 rebounds, such that the end wall 1112 is engaged with the limiting step 316, thus locking the first pedal 1 in the first retracted position. In this case, the protruding block 1113 and the bearing plate 211 of the second pressing portion 21 abut against each other, and the second pedal 2 is kept in the second pop-up position. When the second pedal 2 moves from the second pop-up position to the second retracted position, the second pressing portion 21 pushes the protruding block 1113, such that the elastic arm 111 is deformed toward the direction approaching to the body portion 13, and the end wall 1112 can be easily disengaged from the limiting step 316, and the first pedal 1 automatically moves to the first pop-up position, for example, under the action of the first elastic member 51.

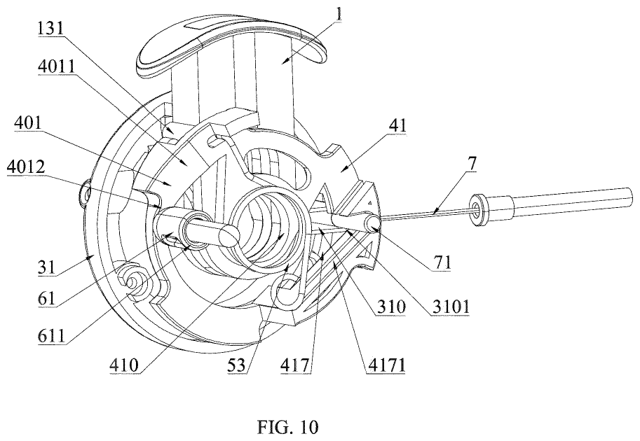

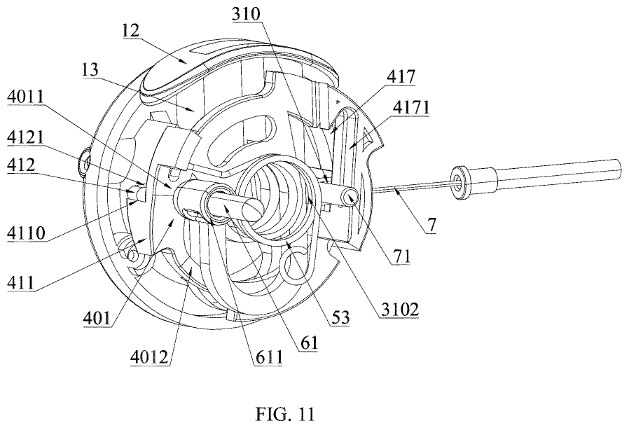

FIGS. 10 and 11 show an exemplary configuration in which the first pedal 1 drives the first locking pin 61 to move. The brake mechanism 100 further includes a first rotatable plate 41. The first rotatable plate 41 is sleeved on a second pivot shaft 302 (see FIG. 4) through a central hole 410 thereof. The second pivot shaft 302 is, for example, a hollow shaft formed inside the intermediate housing 33. A central shaft 911 (see FIG. 3) of the first wheel 91 extends through a hole 320 (see FIGS. 7 to 9) of the second end cover 32 and the second pivot shaft 302. An end wall of the first rotatable plate 41 includes a first inclined portion 401 extending in the circumferential direction. The first inclined portion 401 includes a first protruding end 4011 and a first avoiding end 4012. The first protruding end 4011 and the first avoiding end 4012 have different heights in the axial direction. The first locking pin 61 is parallel to the second pivot shaft 302 and abuts against the first inclined portion 401. When the first pedal 1 moves between the first pop-up position and the first retracted position, the first rotatable plate 41 can be driven to rotate, such that an end of the first locking pin 61 selectively abuts against the first protruding end 4011 and the first avoiding end 4012. When the first locking pin 61 abuts against the first protruding end 4011, the first locking pin 61 is pushed to the extended position to lock the first wheel 91. Conversely, when the first locking pin 61 abuts against the first avoiding end 4012, the first locking pin 61 is in the retracted position to unlock the first wheel 91.

Referring to FIGS. 10 and 11, in some embodiments, when the first pedal 1 is in the first pop-up position, the first avoiding end 4012 abuts against the first locking pin 61, and the first locking pin 61 unlocks the first wheel 91. When the first pedal 1 is in the first retracted position, the first outer protruding end 4011 abuts against the first locking pin 61, and the first locking pin 61 locks the first wheel 91.

It should be noted that, in some other embodiments, a direction of the first inclined portion 401 can be changed, so as to exchange a position of the first protruding end 4011 with a position of the first avoiding end 4012 of the first inclined portion 401, such that the correlation between the position change of the first pedal 1 and the state change of the brake mechanism 100 is changed. For example, when the first pedal 1 is in the first pop-up position, the first protruding end 4011 abuts against the first locking pin 61, the first locking pin 61 locks the first wheel 91, and the brake mechanism 100 is in the locked state. When the first pedal 1 is in the first retracted position, the first avoiding end 4012 abuts against the first locking pin 61, the first locking pin 61 unlocks the first wheel 91, and the brake mechanism 100 is in an unlocked state.

In some embodiments, a first elastic reset member (not shown) may further be provided between the first locking pin 61 and the housing 3. The first elastic reset member exerts an elastic force on the first locking pin 61 to enable the first locking pin 61 to abut against the first inclined portion 401 of the first rotatable plate 41. The first elastic reset member is, for example, a spring mounted between a step 611 (see FIG. 10) of the first locking pin 61 and the second end cover 32.

Referring to FIGS. 6, 10 and 11, in some embodiments, when the first pedal 1 moves from the first pop-up position to the first retracted position, the first pedal 1 drives the first rotatable plate 41 to rotate in a first direction T1. The brake mechanism 100 may further include a third elastic member 53. The third elastic member 53 can drive the first rotatable plate 41 to rotate in a second direction T2 when the first pedal 1 moves from the first retracted position to the first pop-up position. The first direction T1 is opposite to the second direction T2. The third elastic member 53 is, for example, a torsion spring, which can be sleeved on the second pivot shaft 302. Two spring arms of the torsion spring are, for example, connected to the first rotatable plate 41 and the second end cover 32, respectively. It should be noted that the rotation of the first rotatable plate 41 enables the first locking pin 61 to selectively abut against the first protruding end 4011 and the first avoiding end 4012, such that the first locking pin 61 locks or unlocks the first wheel 91.

FIG. 6 shows an exemplary configuration in which the first pedal 1 drives the first rotatable plate 41 to rotate. The first pedal 1 moves in a radial direction of the second pivot shaft 302. The body portion 13 of the first pedal 1 may be provided with a transmission portion 131 protruding outwardly. The first rotatable plate 41 is provided with a transmission surface 4121. The transmission surface 4121 is inclined relative to a moving direction of the first pedal 1. For example, the transmission portion 131 is kept to abut against the transmission surface 4121 under the action of the third elastic member 53 (see FIGS. 10 and 11). When the first pedal 1 is subjected to the first pressure P1 and moves to the first retracted position, the transmission portion 131 pushes the transmission surface 4121, such that the first rotatable plate 41 rotates in the first direction T1. Conversely, when the first pressure P1 is removed and the first pedal 1 is unlocked from the limiting structure, the third elastic member 53 drives the first rotatable plate 41 to rotate in the second direction T2, and in this case, the transmission surface 4121 drives the first pedal 1 to move toward the first pop-up position via the transmission portion 131. It should be understood that, if the third elastic member 53 drives the first pedal 1 to move from the first retracted position to the first pop-up position, the aforementioned first elastic member 51 can be omitted.

In some other embodiments, the position of the transmission portion 131 on the first pedal 1 is interchangeable with the position of the transmission surface 4121 on the first rotatable plate 41, as long as the movement of one of the first pedal 1 and the first rotatable plate 41 can drive the corresponding movement of the other of the first pedal 1 and the first rotatable plate 41.

FIGS. 4 and 6 show an exemplary configuration of the first rotatable plate 41. In some embodiments, the first rotatable plate 41 includes a disc-shaped body 411 and a push rod 412 arranged coaxially with the disc-shaped body 411. A central hole of the disc-shaped body 411 allows the second pivot shaft 302 to extend through. One end of the push rod 412 is sleeved on the second pivot shaft 302 via a hole 4120. The first inclined portion 401 is positioned, for example, on a first end wall of the disc-shaped body 411. The second end wall of the disc-shaped body 411 includes a blocking portion 4110. The push rod 412 is clamped between the blocking portion 4110 and the transmission portion 131 of the first pedal 1. The transmission surface 4121 is formed on the push rod 412. By dividing the first rotatable plate 41 into the disc-shaped body 411 and the push rod 412, both the disc-shaped body 411 and the push rod 412 can be manufactured relatively easily, which is beneficial to reduce the manufacturing difficulty of the first rotatable plate 41. In some alternative embodiments, the push rod 412 can be omitted, and the transmission surface 4121 may be directly formed on the disc-shaped body 411.

Referring to FIGS. 4 and 6, in some embodiments, the body portion 13 is provided with a first guide hole 1301. The second pivot shaft 302 is slidably fitted with the first guide hole 1301 to limit a moving distance of the first pedal 1. In addition, the body portion 13 may further be provided with a second guide hole 1302. A guide rod 3302 may be disposed in the opening 330. The guide rod 3302 is slidably fitted with the second guide hole 1302. The cooperation between the second pivot shaft 302 and the first guide hole 1301 and the cooperation between the guide rod 3302 and the second guide hole 1302 can guide the movement of the first pedal 1 in the linear direction. In some alternative embodiments, the opening 330 is slidably fitted with the body portion 13, and the body portion 13 may not be provided with the second guide hole 1302. Referring to FIGS. 4 and 5, the aforementioned first elastic member 51 may be disposed between the guide rod 3302 and the first treading portion 12. Enabling the first pedal 1 to move in the linear direction can also be realized in other ways, and which is not limited hereto.

A working principle of the brake mechanism 100 according to the above-mentioned embodiment will be briefly described below.
1. When the brake mechanism 100 is in the unlocked state, the first pedal 1 is in the first pop-up position, the second pedal 2 is in the second retracted position, and the first avoiding end 4012 of the first rotatable plate 41 is in contact with the first locking pin 61, the first locking pin 61 is disengaged from the locking portion 910 of the first wheel 91.
2. When it is required to switch the brake mechanism 100 from the unlocked state to the locked state, the first pedal 1 is stepped on downward, the first pedal 1 moves downward under the action of the first pressure P1, and the transmission portion 131 of the first pedal 1 pushes the transmission surface 4121 of the push rod 412, such that the push rod 412 is subjected to a force and rotates to drive the disc-shaped body 411 to rotate in the first direction T1, and the first inclined portion 401 of the disc-shaped body 411 pushes the first locking pin 61 toward the locking portion 910. During the downward movement of the first pedal 1, the protruding block 1113 of the elastic arm 111 pushes the upper surface of the bearing plate 211 of the second pedal 2, such that the second pedal 2 rotates upward around the first pivot shaft 301. When the first pedal 1 moves downward to a position, the end wall 1112 of the elastic arm 111 is engaged with the limiting step 316. The first pressure P1 is removed, the first pedal 1 is kept in the first retracted position, and the protruding block 1113 is kept to abut against the bearing plate 211, such that the second pedal 2 is kept in the second pop-up position. The first protruding end 4011 of the first inclined portion 401 abuts against the first locking pin 61, and the first locking pin 61 is engaged with the locking portion 910 of the first wheel 91.
3. When it is required to switch the brake mechanism 100 from the locked state to the unlocked state, the second pedal 2 is stepped on downward, such that the second pedal 2 rotates downward around the first pivot shaft 301 under the action of the second pressure P2, and the bearing plate 211 of the second pedal 2 pushes the protruding block 1113 of the elastic arm 111, such that the elastic arm 111 is elastically deformed, and the end wall 1112 is disengaged from the limiting step 316. Even if the second pressure P2 is removed at this time, the second pedal 2 can move to the second retracted position under the action of the second elastic member 52, and the first pedal 1 can move to the first pop-up position under the action of the first elastic member 51. Correspondingly, the disc-shaped body 411 rotates in the second direction T2 under the action of the third elastic member 53, and the first locking pin 61 is withdrawn from the locking portion 910 under the action of the first elastic reset member. The rotation of the disc-shaped body 411 drives the push rod 412 to rotate. The transmission surface 4121 of the push rod 412 drives the transmission portion 131 of the first pedal 1, and exerts a force on the first pedal 1 to move the first pedal 1 toward the first pop-up position. When the first pedal 1 moves upward to the first pop-up position, the first avoiding end 4012 of the first inclined portion 401 abuts against the first locking pin 61, and the first locking pin 61 is disengaged from the locking portion 910 of the first wheel 91.

The embodiments of the present disclosure provide a dual-pedal brake mechanism with a simple structure. The locking operation and unlocking operation of the brake mechanism 100 only require stepping on the corresponding pedals, which improves the user's experience.

Referring to FIGS. 12 and 13, an embodiment of the present disclosure further provides a brake system 1000, including an auxiliary brake mechanism 200 and the aforementioned brake mechanism 100. The first rotatable plate 41 is operatively connected to the auxiliary brake mechanism 200 through a pulling member 7. In some embodiments, when the brake mechanism 200 locks the first wheel 91, the first rotatable plate 41 acts on the auxiliary brake mechanism 200 through the pulling member 7, such that the auxiliary brake mechanism 200 locks the second wheel 92, thereby realizing the function of double braking with one stepping.

Referring to FIGS. 10 and 11, in some embodiments, a first end of the pulling member 7 is provided with a connecting head 71, and a second end 72 of the pulling member 7 is connected to the auxiliary brake mechanism 200. A sliding slot 310 is disposed in an inner cavity of the housing 3. The sliding slot 310 can be, for example, disposed on the first end cover 31. The sliding slot 310 is slidably fitted with the connecting head 71. The sliding slot 310 includes a radially outer end 3101 and a radially inner end 3102. The connecting head 71 is movably connected to the first rotatable plate 41. When the first rotatable plate 41 rotates, the connecting head 71 moves between the radially outer end 3101 and the radially inner end 3102 of the sliding slot 310, so as to drive the auxiliary brake mechanism 200 to lock or unlock the second wheel 92.

Referring to FIGS. 12 and 13, in some embodiments, the auxiliary brake mechanism 200 includes a second rotatable plate 42 and a second locking pin 62. The second rotatable plate 42 is sleeved on a third pivot shaft (not shown) through a central hole 420. The third pivot shaft is for example mounted on the rear leg frame 93 of the movable frame. The third pivot shaft and the second wheel 92 are coaxially disposed. An end wall of the second rotatable plate 42 includes a second inclined portion 402 extending in the circumferential direction. The second inclined portion 402 includes a second protruding end 4021 and a second avoiding end 4022. The second locking pin 62 is parallel to the third pivot shaft and abuts against the second inclined portion 402. When the second locking pin 62 abuts against the second protruding end 4021, the second locking pin 62 is in an extended position to lock the second wheel 92. When the second locking pin 62 abuts against the second avoiding end 4022, the second locking pin 62 is in a retracted position to unlock the second wheel 92.

The second end 72 of the pulling member 7 is connected to the second rotatable plate 42. When the connecting head 71 moves between the radially outer end 3101 and the radially inner end 3102 of the sliding slot 310, the second rotatable plate 42 rotates accordingly, such that the second locking pin 62 selectively abuts against the second protruding end 4021 and the second avoiding end 4022.

In some embodiments, referring to FIGS. 10 and 12, when the first pedal 1 is in the first pop-up position, the first locking pin 61 unlocks the first wheel 91. In this case, the connecting head 71 is at the radially outer end 3101 of the sliding slot 310, the second avoiding end 4022 of the second rotatable plate 42 abuts against the second locking pin 62, and the second locking pin 62 is disengaged from the locking portion of the second wheel 92 (not shown), such that the auxiliary brake mechanism 200 is in an unlocked state.

Referring to FIGS. 11 and 13, when the first pedal 1 moves to the first retracted position, the first rotatable plate 41 drives the first locking pin 61 to lock the first wheel 91, and the first rotatable plate 41 drives the connecting head 71 to move toward the radially inner end 3102 of the sliding slot 310. In this case, the pulling member 7 drives the second rotatable plate 42 to rotate, such that the second protruding end 4021 of the second inclined portion 402 abuts against the second locking pin 62, and the second locking pin 62 is pushed to be engaged with the locking portion of the second wheel 92, and the auxiliary brake mechanism 200 is in a locked state.

The auxiliary brake mechanism 200 may further includes a fourth elastic member (not shown). The fourth elastic member is, for example, a torsion spring, connected to the second rotatable plate 42. When the first pedal 1 moves to the first pop-up position, the fourth elastic member can drive the second rotatable plate 42 to rotate, such that the second avoiding end 4022 of the second inclined portion 402 abuts against the second locking pin 62 to unlock the second wheel 92 and drive the connecting head 7 to move from the radially inner end 3102 to the radially outer end 3101 of the sliding slot 310.

In some embodiments, the first rotatable plate 41 includes a concave portion 417 configured to receive the connecting head 71. The concave portion 417 includes an abutting wall 4171 that is slidably fitted with the connecting head 71. The abutting wall 4171 is a non-radial surface. When the first rotatable plate 41 rotates, the connecting head 71 keeps abutting against the abutting wall 4171 and slides between the radially inner end 3102 and the radially outer end 3101 of the sliding slot 310.

In some alternative embodiments, a direction of the second inclined portion 402 can be changed, such that a position of the second protruding end 4021 can be exchanged with a position of the second avoiding end 4022 of the second inclined portion 402. In this way, when the connecting head 71 is positioned at the radially outer end 3101 of the sliding slot 310, the second protruding end 4021 of the second inclined portion 402 abuts against the second locking pin 62. When the connecting head 71 is positioned at the radially inner end 3102 of the sliding slot 310, the second avoiding end 4022 of the second rotatable plate 42 abuts against the second locking pin 62.

In addition, the second locking pin 62 may further be provided with a second elastic reset member (not shown). The second elastic return member exerts an elastic force on the second locking pin 62 to enable the second locking pin 62 to abut against the second inclined portion 402 of the second rotatable plate 42.

An embodiment of the present disclosure further provides a child carrier, which includes a movable frame, and the brake mechanism 100 or the brake system 200 as described in the above embodiments provided on the movable frame. As mentioned above, the child carrier can include but not limited to a stroller.

When the brake mechanism according to the aforementioned embodiments locks the first wheel and unlocks the first wheel, the first pedal or the second pedal may be stepped on correspondingly, and there is no need to raise the foot against the first pedal or the second pedal, which would not cause injury to user's vamp or instep. The way of stepping down is more in line with the user's living habits, which is convenient for the user to apply force and provides a better use experience for the user.

The technical features of the above-described embodiments may be combined arbitrarily. To simplify the description, not all possible combinations of the technical features in the above embodiments are described. However, all of the combinations of these technical features should be considered as being fallen within the scope of the present disclosure, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. It should be noted that, a person of ordinary skill in the art may further make some variants and improvements without departing from the concept of the present disclosure, and the variants and improvements falls within the protection scope of the present disclosure. Therefore, the protection scope of the present disclosure shall be subject to the appended claims.

1. A brake mechanism configured to lock a first wheel, the brake mechanism comprising:
a first pedal having a first pop-up position and a first retracted position, one of the first pop-up position and the first retracted position corresponding to a locked state of the brake mechanism the other of the first pop-up position and the first retracted position corresponding to an unlocked state of the brake mechanism and
a second pedal operatively connected to the first pedal and having a second pop-up position and a second retracted position,
wherein when the first pedal is in the first retracted position, the second pedal is in the second pop-up position; and when the second pedal is in the second retracted position, the first pedal is in the first pop-up position.

2. The brake mechanism according to claim 1, wherein the first pedal is capable of moving in a linear direction, and the second pedal is sleeved on a first pivot shaft and is capable of rotating around the first pivot shaft.

3. The brake mechanism according to claim 1, wherein the first pedal comprises a first pressing portion and the second pedal comprises a second pressing portion, wherein, when the first pedal moves from the first pop-up position to the first retracted position, the first pressing portion abuts against the second pressing portion, so as to drive the second pedal to move from the second retracted position to the second pop-up position.

4. The brake mechanism according to claim 1, further comprising a limiting structure configured to lock the first pedal to the first pop-up position, wherein when the second pedal moves toward the second retracted position, the second pedal drives the first pedal to be unlocked from the limiting structure.

5. The brake mechanism according to claim 1, further comprising:
a first elastic member configured to drive the first pedal to move from the first retracted position to the first pop-up position; and/or
a second elastic member configured to drive the second pedal to rotate from the second pop-up position to the second retracted position.

6. The brake mechanism according to claim 2, wherein a moving direction of the first pedal is perpendicular to an axial direction of the first pivot shaft.

7. The brake mechanism according to claim 3, wherein the first pedal further comprises a first treading portion and a body portion connected to the first treading portion, wherein the first pressing portion comprises an elastic arm extending from the body portion, and the elastic arm extending obliquely relative to a moving direction of the first pedal.

8. The brake mechanism according to claim 7, wherein the second pedal further comprises a second treading portion and a pivot portion connected to the second treading portion, wherein the pivoting portion is sleeved on the first pivot shaft, the second pressing portion comprises a bearing plate extending from the pivoting portion, and a plane where the bearing plate is positioned intersects a plane where the second treading portion is positioned.

9. The brake mechanism according to claim 8, wherein the elastic arm comprises a protruding block configured to push the bearing plate to rotate.

10. The brake mechanism according to claim 7, further comprising a limiting step, wherein when the first pedal is in the first retracted position, the limiting step is engaged with the elastic arm, so as to lock the first pedal in the first retracted position, and to keep the second pedal in the second pop-up position, wherein, when second pedal moves toward the second retracted position, the second pressing portion drives the elastic arm to elastically deform, such that the elastic arm is disengaged from the limiting step.

11. The brake mechanism according to claim 10, wherein the elastic arm comprises an inclined wall and an end wall, wherein a protruding block is disposed on the inclined wall;
wherein, when the first pedal moves toward the first retracted position, the inclined wall abuts against the limiting step and allows the protruding block to abut against the second pressing portion;
wherein, when the first pedal is in the first retracted position, the end wall is engaged with the limiting step.

12. The brake mechanism according to claim 1, further comprising:
a first rotatable plate sleeved on a second pivot shaft, an end wall of the first rotatable plate comprising a first inclined portion extending in a circumferential direction, the first inclined portion comprising a first protruding end and a first avoiding end; and
a first locking pin parallel to the second pivot shaft and abutting against the first inclined portion, wherein, when the first locking pin abuts against the first protruding end the first locking pin is in an extended position, wherein, when the first locking pin abuts against the first avoiding end, the first locking pin is in a retracted position;
wherein, when the first pedal moves between the first pop-up position and the first retracted position, the first rotatable plate rotates accordingly, such that the first locking pin selectively abuts against the first protruding end and the first avoiding end.

13. The brake mechanism according to claim 12, further comprising a third elastic member, wherein, when the first pedal moves from the first pop-up position to the first retracted position, the first pedal drives the first rotatable plate to rotate in a first direction;
wherein, when the first pedal moves from the first retracted position to the first pop-up position, the third elastic member drives the first rotatable plate to rotate in a second direction opposite to the first direction.

14. The brake mechanism according to claim 12, wherein the first pedal is capable of moving in a radial direction of the second pivot shaft, one of the first pedal and the first rotatable plate comprises a transmission portion, the other of the first pedal and the first rotatable plate is provided with a transmission surface, the transmission surface is inclined relative to a moving direction of the first pedal, and the transmission portion abuts against the transmission surface.

15. The brake mechanism according to claim 14, wherein the first pedal further comprises a first treading portion and a body portion connected to the first treading portion, and the transmission portion protrudes outwardly from the body portion, the first rotatable plate comprises a disc-shaped body and a push rod arranged coaxially with the disc-shaped body, the disc-shaped body comprises a blocking portion the push rod is clamped between the transmission portion and the blocking portion, and the transmission surface is formed on the push rod.

16. The brake mechanism according to claim 1, wherein the first pedal and the second pedal are capable of moving in a linear direction, the first pedal is connected to the second pedal by a connecting rod; and a middle portion of the connecting rod is pivotally connected to a pivot base.

17. A brake system comprising:
an auxiliary brake mechanism;
a pulling member; and
the brake mechanism according to claim 12,
wherein the first rotatable plate is operatively connected to the auxiliary brake mechanism through the pulling member, and the auxiliary brake mechanism is configured to lock the second wheel.

18. The brake system according to claim 17, wherein a first end of the pulling member is provided with a connecting head, and a second end of the pulling member is connected to the auxiliary brake mechanism;
wherein the brake mechanism is provided with a sliding slot slidably fitted with the connecting head, and the sliding slot comprises a radially outer end and a radially inner end;
wherein the connecting head is movably connected to the first rotatable plate, wherein, when the first rotatable plate rotates, the connecting head is capable of moving between the radially outer end and the radially inner end of the sliding slot.

19. The brake system according to claim 18, wherein the first rotatable plate comprises a concave portion configured to receive the connecting head, and the concave portion comprises an abutting wall slidably fitted with the connecting head.

20. The brake system according to claim 18, wherein the auxiliary brake mechanism comprises:
a second rotatable plate sleeved on a third pivot shaft, an end wall of the second rotatable plate comprising a second inclined portion extending in a circumferential direction, and the second inclined portion comprising a second protruding end and a second avoiding end; and
a second locking pin parallel to the third pivot shaft and abutting against the second inclined portion, wherein, when the second locking pin abuts against the second protruding end, the second locking pin is in an extended position to lock the second wheel, wherein, when the second locking pin abuts against the second avoiding end, the second locking pin is in a retracted position to unlock the second wheel;
wherein the second end of the pulling member is connected to the second rotatable plate, wherein, when the connecting head moves between the radially outer end and the radially inner end of the sliding slot, the second rotatable plate rotates accordingly, such that the second locking pin selectively abuts against the second protruding end and the second avoiding end.

21. (canceled)
